(19) United States
(12) Patent Application Publication
(10) Pub. No.: US 2026/0115804 A1
(43) Pub. Date: Apr. 30, 2026

(54) CEMENTED CARBIDE AND CUTTING TOOL

(71) Applicant: Sumitomo Electric Hardmetal Corp., Itami-shi, Hyogo (JP)

(72) Inventors: Yasuki KIDO, Itami-shi, Hyogo (JP); Yuki TANAKA, Itami-shi, Hyogo (JP); Takahiro SEKIYA, Itami-shi, Hyogo (JP)

(73) Assignee: Sumitomo Electric Hardmetal Corp., Itami-shi, Hyogo (JP)

(21) Appl. No.: 19/143,917

(22) PCT Filed: Sep. 26, 2024
(86) PCT No.: PCT/JP2024/034435

§ 371 Date: Jun. 27, 2025

(51) Int. Cl. B23B 27/14; C22C 29/02

(52) U.S. Cl. CPC B23B 27/14; C22C 29/02; B23B 2222/28

(57) ABSTRACT

A cemented carbide is a cemented carbide comprising a first hard phase and a binder phase, wherein a total content of the first hard phase and the binder phase is 80.0 vol % or more, a content of the binder phase is a range from 5.0 vol % to 21.0 vol %, a cobalt content of the binder phase is 50 mass % or more, a percentage (H₆₀₀/H₂₅)×100 of a hardness H₆₀₀ of the cemented carbide at 600° C. to a hardness H₂₅ of the cemented carbide at 25° C. is a range from 50% to 70%, a ratio c/M of a specific heat c of the cemented carbide at 600° C. to a content M of the binder phase is a range from 0.032 to 0.044, the content M of the binder phase is the range from 3.0 mass % to 13.0 mass %, and a unit of the specific heat c is J/g·K.

### TECHNICAL FIELD

The present disclosure relates to a cemented carbide and a cutting tool.

### BACKGROUND ART

Conventionally, a cemented carbide including a plurality of tungsten carbide particles and a binder phase has been used for a material of a cutting tool (PTL 1).

### CITATION LIST

### Patent Literature

PTL 1: Japanese Patent Laying-Open No. 2004-131769

### SUMMARY OF INVENTION

A cemented carbide of the present disclosure is a cemented carbide comprising a first hard phase consisting of a plurality of tungsten carbide particles and a binder phase containing cobalt, wherein a total content of the first hard phase and the binder phase of the cemented carbide is 80.0% by volume or more, a content of the binder phase of the cemented carbide is 5.0% by volume or more and 21.0% by volume or less, a cobalt content of the binder phase is 50% by mass or more, a percentage (H₆₀₀/H₂₅)×100 of a hardness H₆₀₀ of the cemented carbide at 600° C. to a hardness H₂₅ of the cemented carbide at 25° C. is 50% or more and 70% or less, a ratio c/M of a specific heat c of the cemented carbide at 600° C. to a content M of the binder phase of the cemented carbide based on mass is 0.032 or more and 0.044 or less, the content M of the binder phase of the cemented carbide based on mass is 3.0% by mass or more and 13.0% by mass or less, and a unit of the specific heat c is J/g·K.

### BRIEF DESCRIPTION OF DRAWINGS

FIG. 1 is a schematic view of a cutting tool according to Embodiment 2.

### DETAILED DESCRIPTION

### Problem to be Solved by the Present Disclosure

From the viewpoint of cost reduction, there is a demand for a cemented carbide that can prolong a tool life, particularly even when it is used as a material for a cutting tool for high-speed processing of a heat-resistant alloy, and a cutting tool including the same.

### Advantageous Effect of the Present Disclosure

According to the present disclosure, it is possible to provide a cemented carbide that can prolong a tool life, particularly even when it is used as a material for a cutting tool for high-speed processing of a heat-resistant alloy, and a cutting tool including the same.

### DESCRIPTION OF EMBODIMENTS

First, aspects of the present disclosure will be listed and described.

(1) A cemented carbide of the present disclosure is a cemented carbide comprising a first hard phase consisting of a plurality of tungsten carbide particles and a binder phase containing cobalt, wherein a total content of the first hard phase and the binder phase of the cemented carbide is 80.0% by volume or more, a content of the binder phase of the cemented carbide is 5.0% by volume or more and 21.0% by volume or less, a cobalt content of the binder phase is 50% by mass or more, a percentage (H₆₀₀/H₂₅)×100 of a hardness H₆₀₀ of the cemented carbide at 600° C. to a hardness H₂₅ of the cemented carbide at 25° C. is 50% or more and 70% or less, a ratio c/M of a specific heat c of the cemented carbide at 600° C. to a content M of the binder phase of the cemented carbide based on mass is 0.032 or more and 0.044 or less, the content M of the binder phase of the cemented carbide based on mass is 3.0% by mass or more and 13.0% by mass or less, and a unit of the specific heat c is J/g·K.

According to the present disclosure, it is possible to provide a cemented carbide that can prolong a tool life, particularly even when it is used as a material for a cutting tool for high-speed processing of a heat-resistant alloy. The reasons for this are presumed to be as follows.

The cemented carbide of the present disclosure contains a first hard phase consisting of tungsten carbide particles and a binder phase containing cobalt in a total amount of 80.0% by volume or more, the content of the binder phase of the cemented carbide is 5.0% by volume or more and 21.0% by volume or less, and the cobalt content of the binder phase is 50% by mass or more. This allows the cemented carbide to have hardness and toughness suitable for cutting tools.

A percentage (H₆₀₀/H₂₅)×100 of a hardness H₆₀₀ of the cemented carbide of the present disclosure at 600° C. to a hardness H₂₅ of the cemented carbide of the present disclosure at 25° C. is 50% or more and 70% or less. Generally, the hardness of cemented carbide decreases at high temperatures, but a decrease in the hardness of the cemented carbide of the present disclosure is suppressed even at 600° C. Therefore, a cutting tool including a cutting edge consisting of the cemented carbide can have excellent wear resistance even in high-speed processing of a heat-resistant alloy using a ball end mill, in which the cutting edge temperature during processing is about 600° C.

Generally, a metal used in the binder phase of the cemented carbide tends to have a large specific heat at high temperatures, and is resistant to temperature changes due to the absorption of thermal energy. In other words, the heat resistance of the metal used in the binder phase is improved at high temperatures. On the other hand, the specific heat is affected by the content of the binder phase of the cemented carbide. A ratio c/M of a specific heat c of the cemented carbide at 600° C. to a content M of the binder phase of the cemented carbide based on mass is an index of heat resistance that does not depend on the content of the binder phase of the cemented carbide. When the ratio c/M is 0.032 or more, the heat resistance of the cemented carbide at 600° C. is good. When the ratio c/M is 0.044 or less, the cemented carbide is not overheated and strength reduction can be suppressed. Therefore, a cutting tool including a cutting edge consisting of the cemented carbide can have excellent heat resistance even in high-speed processing of a heat-resistant alloy using a ball end mill, in which the cutting edge temperature during processing is about 600° C.

(2) In the above (1), the percentage (H₆₀₀/H₂₅)×100 is 58% or more and 70% or less, the ratio c/M is 0.037 or more and 0.044 or less, the cemented carbide further comprises a second hard phase, and the second hard phase may consist of at least one first compound selected from the group consisting of TiNbC, TiNbN, and TiNbCN.

When the percentage (H₆₀₀/H₂₅)×100 is 58% or more and 70% or less, the reduction of the hardness of the cemented carbide at 600° C. is further suppressed. Therefore, a cutting tool including a cutting edge consisting of the cemented carbide can have more excellent wear resistance even in high-speed processing of a heat-resistant alloy using a ball end mill, in which the cutting edge temperature during processing is about 600° C.

When the cemented carbide comprises a second hard phase consisting of at least one first compound selected from the group consisting of TiNbC, TiNbN, and TiNbCN, the heat resistance and the hardness of the cemented carbide are further improved. Therefore, a cutting tool including a cutting edge consisting of the cemented carbide can have more excellent heat resistance and wear resistance.

(3) In the above (1) and (2), in a cross section of the cemented carbide, a median of areas of the second hard phase is 0.003 μm² or more and 0.050 μm² or less, and a coefficient of variation of the areas of the second hard phase may be 0.50 or more and 3.00 or less. This further improves the heat resistance of the cemented carbide and the balance between the hardness and the strength of the cemented carbide.

Therefore, a cutting tool including a cutting edge consisting of the cemented carbide can have more excellent heat resistance and wear resistance.

(4) In any of the above (1) to (3), in a cross section of the cemented carbide, a median of areas of the tungsten carbide particles is 0.080 μm² or more and 0.150 μm² or less, and a coefficient of variation of the areas of the tungsten carbide particles may be 0.85 or more and 1.10 or less. This further improves the balance between the hardness and the strength of the cemented carbide. Therefore, a cutting tool including a cutting edge consisting of the cemented carbide can have more excellent wear resistance.

(5) A cutting tool of the present disclosure is a cutting tool including a cutting edge consisting of the cemented carbide according to any of the above (1) to (4). The cutting tool of the present disclosure can have a long life particularly even when it is used for high-speed processing of a heat-resistant alloy.

### Details of the Embodiments of the Present Disclosure

With reference to the drawings, specific examples of the cemented carbide and the cutting tool according to the present disclosure will be described below. In the drawings of the present disclosure, the same reference signs represent the same portions or equivalent portions. In addition, a dimensional relationship such as length, width, thickness, or depth is appropriately changed for clarity and simplification of the drawings, and does not necessarily represent an actual dimensional relationship.

As used in the present disclosure, the expression of the format “A to B” means A or more and B or less, and when no unit is written in A and a unit is only written in B, the unit for A and the unit for B are the same.

As used in the present disclosure, when a compound or the like is represented by a chemical formula, if the atomic ratio is not particularly limited, the chemical formula shall include all conventionally known atomic ratios, and should not necessarily be limited only to those within the stoichiometric range.

As used in the present disclosure, when one or more numerical values are written as each of the lower limit and the upper limit of a numerical range, a combination of any one numerical value written as the lower limit and any one numerical value written as the upper limit shall also be disclosed.

In this disclosure, “comprise,” “include,” “have,” and variations thereof are open-ended terms. The open-ended terms may or may not include an additional element in addition to the required elements. The description of “consists of” is a closed term. However, even if a configuration is expressed in the closed term, it may include an additional element that is normally associated impurities or that is unrelated to the target technology.

### Embodiment 1: Cemented Carbide

A cemented carbide of one embodiment (hereinafter also referred to as “Embodiment 1”) of the present disclosure is a cemented carbide that includes a first hard phase consisting of a plurality of tungsten carbide particles and a binder phase containing cobalt. A total content of the first hard phase and the binder phase of the cemented carbide is 80.0% by volume or more. A content of the binder phase of the cemented carbide is 5.0% by volume or more and 21.0% by volume or less. A cobalt content of the binder phase is 50% by mass or more. A percentage (H₆₀₀/H₂₅)×100 of a hardness H₆₀₀ of the cemented carbide at 600° C. to a hardness H₂₅ of the cemented carbide at 25° C. is 50% or more and 70% or less. A ratio c/M of a specific heat c of the cemented carbide at 600° C. to a content M of the binder phase of the cemented carbide based on mass is 0.032 or more and 0.044 or less. The content M of the binder phase of the cemented carbide based on mass is 3.0% by mass or more and 13.0% by mass or less. A unit of the specific heat c is J/g·K.

### <Composition of Cemented Carbide>

The cemented carbide of Embodiment 1 includes a first hard phase consisting of tungsten carbide particles and a binder phase containing cobalt. The total content of the first hard phase and the binder phase of the cemented carbide is 80.0% by volume or more, may be 82% by volume or more and 100% by volume or less, may be 82% by volume or more and 99% by volume or less, may be 92% by volume or more and 99% by volume or less, or may be 95% by volume or more and 99% by volume or less.

The content of the binder phase of the cemented carbide of Embodiment 1 is 5.0% by volume or more and 21.0% by volume or less, may be 7% by volume or more and 20% by volume or less, or may be 10% by volume or more and 18% by volume or less.

The cemented carbide of Embodiment 1 may comprise a second hard phase in addition to the first hard phase and the binder phase. The second hard phase consists of at least one first compound selected from the group consisting of TiNbC, TiNbN, and TiNbCN. The content of the second hard phase of the cemented carbide may be more than 0% by volume and 20% by volume or less, may be 1% by volume or more and 18% by volume or less, may be 2% by volume or more and 8% by volume or less, or may be 3% by volume or more and 6% by volume or less.

The cemented carbide of Embodiment 1 may consist of the first hard phase and the binder phase. Within the scope that does not impair the effect of the present disclosure, the cemented carbide of Embodiment 1 may consist of the first hard phase, the binder phase, and impurities. The cemented carbide of Embodiment 1 may consist of the first hard phase, the binder phase, and the second hard phase. Within the scope that does not impair the effect of the present disclosure, the cemented carbide of Embodiment 1 may consist of the first hard phase, the binder phase, the second hard phase, and impurities.

Examples of the above impurities include iron (Fe), calcium (Ca), silicon (Si), and sulfur(S). The content of the impurities of the cemented carbide is acceptable within the scope that does not impair the effect of the present disclosure. For example, the content of the impurities of the cemented carbide may be 0% by mass or more and less than 0.1% by mass. The content of the impurities of the cemented carbide is measured by ICP emission spectroscopy (Inductively Coupled Plasma Emission Spectroscopy). As the measurement device “ICPS-8100” (trademark) available from SHIMADZU CORPORATION can be used.

A method for measuring the content of the first hard phase, the content of the binder phase, and the content of the second hard phase of the cemented carbide is as follows.

(A1) An arbitrary position of the cemented carbide is cut out to expose a cross section. The cross section is mirror-finished using a cross-section polisher (available from JEOL Ltd.).

(B1) The mirror-finished surface of the cemented carbide is photographed with a scanning electron microscope (SEM) to obtain a backscattered electron image. The photographed region is set to the center of the cross section of the cemented carbide, that is, a position that does not include any portion whose properties are clearly different from the bulk portion, such as the vicinity of the surface of the cemented carbide (a position where the photographed region is entirely the bulk portion of the cemented carbide). The observation magnification is 5000 times. The measurement conditions are an acceleration voltage of 3 kV, a current value of 2 nA, and a working distance (WD) of 5 mm.

(C1) The backscattered electron image obtained in the above (B1) is imported into a computer and is binarized using image analysis software (OpenCV, SciPy). In the image after the binarization processing, the first region consisting of the first hard phase and the second region consisting of the binder phase and the second hard phase can be distinguished by shades of colors. For example, in the image after the binarization processing, the first hard phase is shown as black regions, and the binder phase and the second hard phase are shown as white regions.

(D1) The photographed region of (B1) above is analyzed using an energy dispersive X-ray spectrometer (SEM-EDX) attached to a scanning electron microscope (apparatus: Gemini 450 (trademark) available from Carl Zeiss) to obtain an elemental mapping image.

(E1) The image after the binarization processing obtained in the above (C1) and the elemental mapping image obtained in the above (D1) are overlapped, and each of the existing regions of the first hard phase, the binder phase, and the second hard phase are identified on the image after the binarization processing. The regions, which are shown in black on the image after the binarization processing, and where tungsten (W) and carbon (C) exist on the elemental mapping image, correspond to the existing regions of the first hard phase. The regions, which are shown in white on the image after the binarization processing, and where cobalt (Co) exists on the elemental mapping image, correspond to the existing regions of the binder phase. The regions, which are shown in white on the image after the binarization processing, and where titanium (Ti) or niobium (Nb) exists on the elemental mapping image, correspond to the existing regions of the second hard phase.

(F1) A rectangular measurement field of view of 24.9 μm×18.8 μm is set in the image after the binarization processing. Using the image analysis software, the respective area percentages of the first hard phase, the binder phase, and the second hard phase are measured, with the area of the entire measurement field of view being taken as the denominator.

(G1) The above measurement of (F1) is performed on five different measurement fields of view that are not overlapped with each other. In the present disclosure, the average of the area percentages of the first hard phase in the five measurement fields of view corresponds to the content (% by volume) of the first hard phase in the cemented carbide. The average of the area percentages of the binder phase in the five measurement fields of view corresponds to the content (% by volume) of the binder phase in the cemented carbide. The average of the area percentages of the second hard phase in the five measurement fields of view corresponds to the content (% by volume) of the second hard phase in the cemented carbide.

As long as the measurements are performed on the same sample, it has been confirmed that there is almost no variation in the measurement results even if the above measurements are performed multiple times by changing the selected location of the measurement field of view.

### <First Hard Phase>

### <<Composition>>

In the cemented carbide of Embodiment 1, the first hard phase consists of a plurality of tungsten carbide particles (hereinafter referred to as “WC particles”). The tungsten carbide particles include not only “pure WC particles (including WC that contains no impurity element and WC in which a content of an impurity element is less than the detection limit)” but also “WC particles containing an impurity therein as long as the effect of the present disclosure is not impaired.” Examples of the impurities include iron (Fe), molybdenum (Mo), and sulfur(S).

### <<Median of Areas and Coefficient of Variation of Areas of Tungsten Carbide Particles>>

In a cross section of the cemented carbide of Embodiment 1, the median of areas of the tungsten carbide particles is 0.080 μm² or more and 0.150 μm² or less, and the coefficient of variation of the areas of the tungsten carbide particles may be 0.85 or more and 1.10 or less. The median of areas of the tungsten carbide particles may be 0.084 μm² or more and 0.110 μm² or less, or may be 0.088 μm² or more and 0.108 μm² or less. The coefficient of variation of the areas of the tungsten carbide particles may be 0.90 or more and 1.08 or less, or may be 0.92 or more and 1.05 or less. The above ranges of the median of areas of the tungsten carbide particles and the coefficient of variation of the areas of the tungsten carbide particles may be appropriately combined.

In the present disclosure, the median of areas of the tungsten carbide particles means an area where cumulation of frequencies of the areas of tungsten carbide particles based on number is 50%. In the present disclosure, the coefficient of variation of the areas of the tungsten carbide particles is a value obtained by dividing a standard deviation of the areas of the tungsten carbide particles by an average value of the areas of the tungsten carbide particles (standard deviation/average value). The average value of the areas of the tungsten carbide particles means an arithmetic average of the areas of the tungsten carbide particles. The median of areas and the coefficient of variation of the areas of the second hard phase described below have the same meaning.

In the present disclosure, the method for measuring the median of areas of the tungsten carbide particles and the coefficient of variation of the areas of the tungsten carbide particles in the cross section of the cemented carbide is as follows.

(A2) In the same manners as in the (A1) to (E1) of the method for measuring the content of the first hard phase, the content of the binder phase, and the content of the second hard phase of the above-mentioned cemented carbide, the existing regions of the first hard phase are identified in the image after the binarization processing.

(B2) Five images after the binarization processing, in which the existing regions of the first hard phase are identified, are provided, and a rectangular measurement field of view of 40.3 μm in length×30.2 μm in width is set in each image. Using image analysis software (ImageJ ver. 1.51J8), the outer edge of each tungsten carbide particle in the measurement field of view is identified, and the area of each tungsten carbide particle is measured.

(C2) Based on all tungsten carbide particles in the five measurement fields of view, the median of areas of the tungsten carbide particles and the coefficient of variation of the areas of the tungsten carbide particles are measured. In the present disclosure, the median of areas of the tungsten carbide particles and the coefficient of variation of the areas of the tungsten carbide particles as measured above correspond to the median of areas of the tungsten carbide particles and the coefficient of variation of the areas of the tungsten carbide particles in the cross section of the cemented carbide.

As long as the same sample is measured, it has been confirmed that there is almost no variation in the measurement results even if the above measurement is performed multiple times by changing the selected location of the measurement field of view.

### <Binder Phase>

In the cemented carbide of Embodiment 1, the cobalt content of the binder phase is 50% by mass or more. This allows the cemented carbide to have excellent toughness. The cobalt content of the binder phase may be 80% by mass or more and 100% by mass or less, or may be 90% by mass or more and 100% by mass or less.

The method for measuring the content of cobalt of the binder phase is as follows. An elemental mapping image and an image after the binarization processing are obtained in the same manners as in (A1) to (E1) of the method for measuring the content of the first hard phase, the content of the binder phase, and the content of the second hard phase of the above-mentioned cemented carbide. The elemental mapping image and the image after binarization processing are overlapped to identify the existing regions of the binder phase in the elemental mapping image. A rectangular measurement field of view of 24.9 μm×18.8 μm is set in the elemental mapping image. The cobalt content is measured in the existing regions of the binder phase in the measurement field of view. The above measurement is performed in five different measurement fields of view that do not overlap each other. In the present disclosure, the average of the cobalt contents in the existing regions of the binder phase in the five measurement fields of view corresponds to the cobalt content of the binder phase.

As long as the same sample is measured, it has been confirmed that there is almost no variation in the measurement results even if the above measurement is performed multiple times by changing the selected location of the measurement field of view.

In the cemented carbide of Embodiment 1, the binder phase may further contain at least one first element selected from the group consisting of silicon, germanium, rhenium, and ruthenium. This improves the deformation resistance of the binder phase. The binder phase may consist of cobalt and the first element.

In the cemented carbide of Embodiment 1, the binder phase may contain, in addition to cobalt and the first element, at least one second element selected from the group consisting of iron, nickel, and chromium. The binder phase may consist of cobalt, the first element, and the second element.

### <Second Hard Phase>

### <<Composition>>

In Embodiment 1, the second hard phase consists of at least one first compound selected from the group consisting of TiNbC, TiNbN, and TiNbCN. In the present disclosure, each of TiNbC, TiNbN, and TiNbCN is not limited to a case where a ratio between the total number of atoms of Ti and Nb and the total number of atoms of C and N is 1:1, and may include any conventionally known ratio as long as the effect of the present disclosure is not impaired.

The second hard phase may contain metal elements such as tungsten (W), chromium (Cr), and cobalt (Co) within the range that does not impair the effect of the present disclosure. The total content of W, Cr, and Co in the second hard phase may be 0% by mass or more and less than 0.1% by mass. The contents of W, Cr, and Co in the second hard phase are measured by ICP emission spectroscopy.

A method for measuring the composition of the second hard phase is as follows.

(A3) An arbitrary position of the cemented carbide is sliced using an ion slicer (apparatus: IB09060CIS (trademark) available from JEOL Ltd.) to prepare a sample having a thickness of 30 nm to 100 nm. The accelerating voltage of the ion slicer is 6 kV for the thinning process and 2 kV for the finishing process.

(B3) The above sample is observed at 50,000× magnification with a scanning transmission electron microscope (STEM) (JFM-ARM300F (trademark) available from JEOL Ltd.) to obtain a STEM-HAADF (HAADF: high-angle annular dark field) image. The photographed region of the STEM-HAADF image is set to the center of the sample, that is, a position that does not include any portion whose properties are clearly different from the bulk portion, such as the vicinity of the surface of the cemented carbide (a position where the photographed region is entirely the bulk portion of the cemented carbide). The measurement condition is an acceleration voltage of 200 kV.

(C3) Next, element mapping analysis is performed on the STEM-HAADF image using EDX attached to the STEM, and an elemental mapping image is obtained. In the elemental mapping image, the region where titanium (Ti) and niobium (Nb) and one or both of carbon (C) and nitrogen (N) are present is identified as the second hard phase, and the composition of the second hard phase is identified.

As long as the measurements are performed on the same sample, it has been confirmed that there is almost no variation in the measurement results even if the above measurements are performed multiple times by changing the selected location of the measurement field of view.

### <<Median of Areas and Coefficient of Variation of Areas of Second Hard Phase>>

In a cross section of the cemented carbide of Embodiment 1, a median of areas of the second hard phase is 0.003 μm² or more and 0.050 μm² or less, and a coefficient of variation of the areas of the second hard phase may be 0.50 or more and 3.00 or less. The median of areas of the second hard phase may be 0.012 μm² or more and 0.048 μm² or less. The coefficient of variation of the areas of the second hard phase may be 0.51 or more and 2.98 or less. The above ranges of the median of areas of the second hard phase and the coefficient of variation of the areas of the second hard phase may be appropriately combined.

In the present disclosure, the median of areas of the second hard phase and the coefficient of variation of the areas of the second hard phase in a cross section of the cemented carbide are measured in the same manners as in the method for measuring the median of areas of the tungsten carbide particles and the coefficient of variation of the areas of the tungsten carbide particles in the cross section of the cemented carbide except that, in the image after the binarization processing, the existing regions of the second hard phase are identified, areas of the second hard phase are measured, and a median of areas of the second hard phase and a coefficient of variation of the areas of the second hard phase are measured based on all the second hard phases in the five measurement fields of view. As long as the measurements are performed on the same sample, it has been confirmed that there is almost no variation in the measurement results even if the above measurements are performed multiple times by changing the selected location of the measurement field of view.

### <Hardness>

A percentage (H₆₀₀/H₂₅)×100 of a hardness H₆₀₀ of the cemented carbide of Embodiment 1 at 600° C. to a hardness H₂₅ of the cemented carbide of Embodiment 1 at 25° C. is 50% or more and 70% or less, may be 58% or more and 70% or less, may be 60% or more and 70% or less, or may be 62 or more and 69.5% or less.

The hardness H₂₅ of the cemented carbide of Embodiment 1 at 25° C. may be 12 GPa or more and 25 GPa or less, may be 14 GPa or more and 24 GPa or less, or may be 20 GPa or more and 23 GPa or less.

The hardness H₆₀₀ of the cemented carbide of Embodiment 1 at 600° C. may be 7 GPa or more and 17 GPa or less, may be 10 GPa or more and 15 GPa or less, or may be 12 GPa or more and 14 GPa or less.

In the present disclosure, the hardness H₂₅ of the cemented carbide at 25° C. and the hardness H₆₀₀ of the cemented carbide at 600° C. are measured using a high-temperature micro Vickers hardness tester (“HTM-1200” (trademark) available from INTESCO). First, an indenter setting temperature and a sample setting temperature are set to 25° C., and the hardness H₂₅ of a sample consisting of the cemented carbide at 25° C. is measured. Then, the indenter setting temperature and the sample setting temperature are set to 600° C., and the hardness H₆₀₀ of the cemented carbide at 600° C. is measured. The temperature increasing rates of the indenter and the sample are 20° C./min. The measurement is performed in a vacuum atmosphere. After the setting temperature is reached, the setting temperature is maintained for 5 minutes, and then the measurement is performed. The measurement conditions are a load of 1000 gf and a maintaining time of 30 seconds. The hardness H₂₅ and the hardness H₆₀₀ are measured at 10 points on one sample. In the present disclosure, an average of the hardness H₂₅ at 10 points corresponds to the hardness H₂₅ of the cemented carbide. In the present disclosure, an average of the hardness H₆₀₀ at 10 points corresponds to the hardness H₆₀₀ of the cemented carbide.

As long as the measurements are performed on the same sample, it has been confirmed that there is almost no variation in the measurement results even if the above measurements are performed multiple times by changing the measurement portion.

<Ratio c/M>

A ratio c/M of a specific heat c (J/g·K) of the cemented carbide at 600° C. to a content M (% by mass) of the binder phase of the cemented carbide of Embodiment 1 based on mass is 0.032 or more and 0.044 or less, may be 0.037 or more and 0.044 or less, or may be 0.039 or more and 0.044 or less.

The content M of the binder phase of the cemented carbide of Embodiment 1 based on mass is 3.0% by mass or more and 13.0% by mass or less, may be 3.5% by mass or more and 12.5% by mass or less, or may be 4.0% by mass or more and 12.0% by mass or less.

A method for measuring the content M of the binder phase of the cemented carbide based on mass is as follows. An elemental mapping image and an image after the binarization processing are obtained in the same manners as in (A1) to (E1) of the method for measuring the content of the first hard phase, the content of the binder phase, and the content of the second hard phase of the above-mentioned cemented carbide. The elemental mapping image and the image after binarization processing are overlapped to identify the existing regions of the binder phase in the elemental mapping image. A rectangular measurement field of view of 24.9 μm×18.8 μm is set in the elemental mapping image. Based on the elemental mapping image, the content of the binder phase based on mass relative to the entire measurement field of view is measured. The above measurement is performed in five different measurement fields of view that do not overlap each other. In the present disclosure, an average of the contents of the binder phase based on mass in the five measurement fields of view corresponds to the content M of the binder phase of the cemented carbide based on mass.

As long as the measurements are performed on the same sample, it has been confirmed that there is almost no variation in the measurement results even if the above measurements are performed multiple times by changing the measurement portion.

The specific heat c of the cemented carbide at 600° C. may be 0.103 J/g·K or more and 0.481 J/g·K or less, or may be 0.200 J/g·K or more and 0.350 J/g·K or less.

In the present disclosure, the specific heat c of the cemented carbide at 600° C. is measured using a thermogravimetry/differential heat simultaneous measuring device (“STA 449 F3” (trademark) available from NETZSCH Japan K.K.). The atmosphere during the measurement is an Ar flow at 100 mL/min. The measurement is performed in a step of 50° C.

### <Method for Producing Cemented Carbide>

The cemented carbide of Embodiment 1 can be produced by performing a providing step of raw material powders, a mixing step, a compacting step, a sintering step, a HIP (Hot Isostatic Pressing) step, and a reheat treatment step in the above order. Each step will be described below.

### <Providing Step>

The providing step is a step of providing raw material powders of a material that constitutes the cemented carbide. Examples of the raw material powders include tungsten carbide powder (hereinafter, also referred to as “WC powder”) and Co powder. As the WC powders, “WC04NRP” (average particle diameter by the Fisher method: 0.45 μm to 0.49 μm) and “WC02NP” (particle diameter calculated in terms of the BET method: 0.10 μm to 0.13 μm) available from A.L.M.T. Corp. are used in a mass ratio of WC04NRP:WC02NP=1:1. The average particle diameter of the Co powder is 0.5μ m.

Furthermore, VC powder, Cr₃C₂ powder, TiO₂ powder, Nb₂O₅ powder, TiN powder, Ni powder, Ru powder, Re powder, Si powder, TiCN powder, and the like can be provided as raw material powders. As these raw material powders, commercially available products can be used. The average particle diameters of these raw material powders are not particularly limited, and may be, for example, 0.5 μm to 2 μm. The average particle diameter of the raw material powder means an average particle diameter measured by the FSSS (Fisher Sub-Sieve Sizer) method. The average particle diameter is measured using “Sub-Sieve Sizer Model 95” (trademark) available from Fisher Scientific.

### <Mixing Step>

The mixing step is a step of mixing the raw material powders provided in the providing step in a predetermined proportion to obtain a mixed powder. The mixing proportion of each raw material powder is appropriately adjusted according to the composition of the cemented carbide to be targeted.

A bead mill is used to mix the raw material powders. The mixing conditions are a rotation speed of 3000 rpm, a ball diameter of φ1 mm, and a mixing time of 6 hours.

After the mixing step, the mixed powder may be granulated if necessary. Granulating the mixed powder makes it easier to fill the mixed powder into a die or mold during the compacting step described below. A known granulation method can be applied to granulation, and, for example, a commercially available granulator such as a spray dryer can be used.

### <Compacting Step>

The compacting step is a step of compacting the mixed powder obtained in the mixing step into a predetermined shape for a cutting tool to obtain a compact. As the compacting method and the compacting conditions in the compacting step, a general method and general conditions may be adopted and are not particularly limited.

### <Sintering Step>

The sintering step is a step of sintering the compact obtained in the compacting step to obtain a cemented carbide intermediate. The compact is placed in a sintering furnace, heated to 1450° C. at a temperature increasing rate of 20° C./min under a vacuum or nitrogen atmosphere, and maintained at 1450° C. for 2 hours. The compact is then cooled to 1000° C. at a temperature decreasing rate of −50° C./min. Five sets of heating and cooling described above are repeated. The compact is then cooled to 25° C. at a temperature decreasing rate of −20° C./min to obtain a cemented carbide intermediate.

### <HIP Step>

The HIP step is a step of performing HIP on the cemented carbide intermediate. The HIP is performed under the conditions of an Ar atmosphere, 200 MPa, and maintaining at 1350° C. for 2 hours.

### <Reheat Treatment Step>

The reheat treatment step is a step of performing a heat treatment on the cemented carbide intermediate obtained after the HIP step, followed by cooling, to obtain a cemented carbide of Embodiment 1. The conditions of the reheat treatment are maintaining under vacuum at 1100° C. for 2 hours. Conventional known conditions can be used for the cooling conditions.

### <Characteristics of Method for Producing Cemented Carbide of Embodiment 1>

In the method for producing the cemented carbide of Embodiment 1, two types of WC powders having different particle diameters are used as the WC powder. This densifies the cemented carbide structure, and improves the hardness and the heat resistance of the cemented carbide at 600° C.

In the method for producing the cemented carbide of Embodiment 1, fine Co powder having an average particle diameter of 0.5 μm is used. This improves the sintering property of the cemented carbide and improves the hardness and the heat resistance of the cemented carbide at 600° C.

In the mixing step of the method for producing the cemented carbide of Embodiment 1, the raw material powders are mixed at a high speed using ultrafine balls. This facilitates fining of the raw material powders, improves the sintering property of the cemented carbide, and improves the hardness and the heat resistance of the cemented carbide at 600° C.

In the sintering step of the method for producing the cemented carbide of Embodiment 1, the compact is heated to 1450° C. at a temperature increasing rate of 20° C./min, maintained for two hours, and cooled to 1000° C. at a temperature decreasing rate of −50° C./min, which is repeated for five sets. This rearranges the structure due to liquefaction of the binder phase, and improves the heat resistance of the cemented carbide at 600° C. In a conventionally general sintering step, only one set of heating and cooling has been performed. In this case, the structure is not rearranged due to liquefaction of the binder phase, and the heat resistance of the cemented carbide is insufficient.

In the HIP step of the method for producing the cemented carbide of Embodiment 1, high-temperature high-pressure HIP is performed. This densifies the cemented carbide structure, and improves the hardness of the cemented carbide at 600° C. In the conventional method for producing a general cemented carbide, HIP is often not performed from the viewpoint of cost reduction. Alternatively, even if HIP is performed, the pressure is low (e.g., 10 MPa), and therefore the hardness of the cemented carbide at 600° C. is insufficient.

The method for producing the cemented carbide of Embodiment 1 includes a reheat treatment step. The reheat treatment step can remove impurities from the structure of the cemented carbide intermediate obtained after the HIP step. This improves the hardness of the cemented carbide at 600° C. In the conventional method for producing a general cemented carbide, the reheat treatment step is not performed, and therefore the hardness of the cemented carbide at 600° C. is insufficient.

As a result of extensive researches, the present inventors have found that the above-mentioned production steps can be adopted to achieve the cemented carbide of the present disclosure.

### Embodiment 2: Cutting Tool

A cutting tool of one embodiment of the present disclosure (hereinafter also referred to as “Embodiment 2”) includes a cutting edge consisting of the cemented carbide of Embodiment 1. In the present disclosure, the cutting edge means a portion involved in cutting. More specifically, the cutting edge means a region surrounded by a cutting edge ridgeline thereof and a virtual plane at a distance of 0.5 mm or 2 mm from the cutting edge ridgeline toward the cemented carbide side.

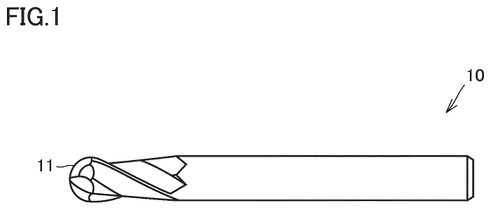

Examples of the cutting tool can include a cutting bit, a drill, an end mill, an indexable cutting insert for milling working, an indexable cutting insert for turning working, a metal saw, a gear cutting tool, a reamer, and a tap. In particular, as shown in FIG. 1, a cutting tool 10 of Embodiment 2 can exhibit an excellent effect in the case of an end mill. A cutting edge 11 of cutting tool 10 shown in FIG. 1 consists of the cemented carbide of Embodiment 1.

The cemented carbide of Embodiment 1 in the cutting tool of Embodiment 2 may constitute the whole of each of these tools, or may constitute a part thereof. Here, the term “constitute a part” refers to, for example, an aspect in which a cutting edge portion is formed by brazing the cemented carbide of Embodiment 1 at a predetermined position of an arbitrary base material.

The cutting tool of Embodiment 2 may further include a hard film that coats at least a part of the surface of a base material consisting of the cemented carbide. For example, diamond-like carbon or diamond can be used as the hard film.

The cutting tool of Embodiment 2 can be obtained by compacting the cemented carbide of Embodiment 1 to a desired shape.

### EXAMPLES

The present embodiment will be described more specifically with reference to Examples. However, the present embodiment is not limited by these Examples.

### [Production of Cemented Carbide]

Each sample of the cemented carbide was produced according to the following procedure.

### <Providing Step>

As the raw material powders, “WC04NRP” (average particle diameter by the Fisher method: 0.45 μm to 0.49 μm) and “WC02NP” (particle diameter calculated in terms of the BET method: 0.10 μm to 0.13 μm) available from A.L.M.T. Corp., Co powder, VC powder, Cr₃C₂ powder, TiO₂ powder, Nb₂O₅ powder, TiN powder, Ni powder, Ru powder, Re powder, Si powder, Ge powder, and TiCN powder were provided in the proportions described in Table 1. The proportions (% by mass) of the respective raw material powders shown in Table 1 are the proportions when the entire raw material powder is considered as 100% by mass. In Sample 102, Co powder having an average particle diameter of 5 μm available from Kojundo Chemical Laboratory Co., Ltd. was used as the Co powder. In the samples other than Sample 102, Co powder having an average particle diameter of 0.5 μm available from Umicore was used as the Co powder. The average particle diameters of the raw material powders other than the WC powder and the Co powder are 1 μm.

TABLE 1

| | Raw material powder | | | | | | | | |
|---|---|---|---|---|---|---|---|---|---|
| | WC02NP | WC04NRP | Co | VC | Cr₃C₂ | TiO₂ | Nb₂O₅ | Others | |
| Sample | % by | % by | % by | % by | % by | % by | % by | | % by |
| No. | mass | mass | mass | mass | mass | mass | mass | Composition | mass |
| 1 | 45.5 | 45.5 | 8.0 | 0.2 | 0.8 | 0 | 0 | — | — |
| 2 | 45.3 | 45.3 | 8.0 | 0.2 | 0.8 | 0.4 | 0.04 | — | — |
| 3 | 45.3 | 45.3 | 8.0 | 0.2 | 0.8 | 0.2 | 0.04 | TiN | 0.2 |
| 4 | 45.3 | 45.3 | 8.0 | 0.2 | 0.8 | 0.4 | 0.04 | — | — |
| 5 | 48.3 | 48.3 | 3.0 | 0 | 0.4 | 0 | 0 | — | — |
| 6 | 43.3 | 43.3 | 13.0 | 0 | 0.4 | 0 | 0 | — | — |
| 7 | 45.5 | 45.5 | 4.2 | 0.2 | 0.8 | 0 | 0 | Ni | 3.8 |
| 8 | 45.3 | 45.3 | 7.5 | 0.2 | 0.8 | 0.4 | 0.04 | Ru | 0.5 |
| 9 | 45.5 | 45.5 | 7.5 | 0.2 | 0.8 | 0 | 0 | Re | 0.5 |
| 10 | 45.5 | 45.5 | 7.5 | 0.2 | 0.8 | 0 | 0 | Si | 0.5 |
| 11 | 45.5 | 45.5 | 7.5 | 0.2 | 0.8 | 0 | 0 | Ge | 0.5 |
| 12 | 42.2 | 42.2 | 8.0 | 0.2 | 0.8 | 0 | 0.6 | TiCN | 6.0 |
| 101 | 91.0 | 0.0 | 8.0 | 0.2 | 0.8 | 0 | 0 | — | — |
| 102 | 45.5 | 45.5 | 8.0 | 0.2 | 0.8 | 0 | 0 | — | — |
| 103 | 45.5 | 45.5 | 8.0 | 0.2 | 0.8 | 0 | 0 | — | — |
| 104 | 45.5 | 45.5 | 8.0 | 0.2 | 0.8 | 0 | 0 | — | — |
| 105 | 45.5 | 45.5 | 8.0 | 0.2 | 0.8 | 0 | 0 | — | — |
| 106 | 45.5 | 45.5 | 8.0 | 0.2 | 0.8 | 0 | 0 | — | — |
| 107 | 48.4 | 48.4 | 2.8 | 0 | 0.4 | 0 | 0 | — | — |
| 108 | 43.1 | 43.1 | 13.5 | 0 | 0.4 | 0 | 0 | — | — |
| 109 | 45.5 | 45.5 | 3.8 | 0.2 | 0.8 | 0 | 0 | Ni | 4.2 |
| 110 | 41.6 | 41.6 | 8.0 | 0.2 | 0.8 | 0 | 0.8 | TiCN | 7.0 |

### <Mixing Step>

In the mixing step, each raw material powder was mixed under the following conditions of A or B. The conditions used for each sample are shown in Table 2. The conditions of B are the conventional general mixing conditions.

A: A bead mill is used. The mixing conditions are a rotation speed of 3000 rpm, a ball diameter of φ1 mm, and mixing time of 6 hours.

B: Atritor is used. The mixing conditions are a rotation speed of 100 rpm, a ball diameter of φ6 mm, and mixing time of 6 hours.

### <Compacting Step>

The mixed powder was pressed to obtain a round bar-shaped compact.

### <Sintering Step>

The compact was placed in a sintering furnace and heated to the temperature described in the “Temperature” column of Table 2 at a temperature increasing rate of 20° C./min, and maintained at that temperature for the time described in the “Time” column, under the conditions described in the “Atmosphere” column of the “Sintering” of Table 2 (“vac” means vacuum, and “N₂” means nitrogen atmosphere). The compact was then cooled to 1000° C. at the temperature decreasing rate described in the “Temperature decreasing rate” column of Table 2. The heating and cooling described above were repeated for the number of times described in the “Number of sets” column of Table 2. The compact was then cooled to 25° C. at a temperature decreasing rate of −20° C./min to obtain a cemented carbide intermediate. The description of “0” for “Number of sets” in Sample 103 indicates that the compact was heated to 1400° C. under vacuum at a temperature increasing rate of 20° C./min, maintained at 1400° C. for 1 hour, and then cooled to 25° C. at a temperature decreasing rate of −20° C./min.

TABLE 2

| | | Sintering | | | | |
|---|---|---|---|---|---|---|
| | | | | | Temperature | Number of |
| | | | Temperature | Time | decreasing rate | sets |
| Sample No. | Mixing | Atmosphere | ° C. | hr | ° C./min | Number |
| 1 | A | vac | 1450 | 2 | −50 | 5 |
| 2 | A | vac | 1450 | 2 | −50 | 5 |
| 3 | A | N₂ | 1450 | 2 | −50 | 5 |
| 4 | A | N₂ | 1450 | 2 | −50 | 5 |
| 5 | A | vac | 1450 | 2 | −50 | 5 |
| 6 | A | vac | 1450 | 2 | −50 | 5 |
| 7 | A | vac | 1450 | 2 | −50 | 5 |
| 8 | A | N₂ | 1450 | 2 | −50 | 5 |
| 9 | A | vac | 1450 | 2 | −50 | 5 |
| 10 | A | vac | 1450 | 2 | −50 | 5 |
| 11 | A | vac | 1450 | 2 | −50 | 5 |
| 12 | A | N₂ | 1450 | 2 | −50 | 5 |
| 101 | A | vac | 1450 | 2 | −50 | 5 |
| 102 | A | vac | 1450 | 2 | −50 | 5 |
| 103 | B | vac | 1400 | 1 | −20 | 0 |
| 104 | A | vac | 1450 | 2 | −50 | 1 |
| 105 | A | vac | 1450 | 2 | −50 | 5 |
| 106 | A | vac | 1450 | 2 | −50 | 5 |
| 107 | A | vac | 1450 | 2 | −50 | 5 |
| 108 | A | vac | 1450 | 2 | −50 | 5 |
| 109 | A | vac | 1450 | 2 | −50 | 5 |
| 110 | A | N₂ | 1450 | 2 | −50 | 5 |

### <HIP Step>

The cemented carbide intermediate was subjected to HIP under the conditions described in the “HIP” column of Table 3.

### <Reheat Treatment Step>

In the samples marked “Done” in the “Reheat treatment” column of Table 3, a heat treatment was performed on the cemented carbide intermediate obtained after the HIP step, and the cemented carbide intermediate was maintained under vacuum at 1100° C. for 2 hours, and then cooled to obtain a cemented carbide. In the sample marked “Not done”, the reheat treatment was not performed.

TABLE 3

| | HIP | | | |
|---|---|---|---|---|
| Sample | Atmosphere/ | Temperature | Time | Reheat treatment |
| No. | pressure | ° C. | hr | Done/not done |
| 1 | Ar/200 MPa | 1350 | 2 | Done |
| 2 | Ar/200 MPa | 1350 | 2 | Done |
| 3 | Ar/200 MPa | 1350 | 2 | Done |
| 4 | Ar/200 MPa | 1350 | 2 | Done |
| 5 | Ar/200 MPa | 1350 | 2 | Done |
| 6 | Ar/200 MPa | 1350 | 2 | Done |
| 7 | Ar/200 MPa | 1350 | 2 | Done |
| 8 | Ar/200 MPa | 1350 | 2 | Done |
| 9 | Ar/200 MPa | 1350 | 2 | Done |
| 10 | Ar/200 MPa | 1350 | 2 | Done |
| 11 | Ar/200 MPa | 1350 | 2 | Done |
| 12 | Ar/200 MPa | 1350 | 2 | Done |
| 101 | Ar/200 MPa | 1350 | 2 | Done |
| 102 | Ar/200 MPa | 1350 | 2 | Done |
| 103 | Ar/200 MPa | 1350 | 2 | Done |
| 104 | Ar/200 MPa | 1350 | 2 | Done |
| 105 | Ar/200 MPa | 1350 | 2 | Not done |
| 106 | Ar/10 MPa | 1300 | 1 | Done |
| 107 | Ar/200 MPa | 1350 | 2 | Done |
| 108 | Ar/200 MPa | 1350 | 2 | Done |
| 109 | Ar/200 MPa | 1350 | 2 | Done |
| 110 | Ar/200 MPa | 1350 | 2 | Done |

### [Evaluation of Cemented Carbide]

### <Content of First Hard Phase, Content of Binder Phase, and Content of Second Hard Phase of Cemented Carbide>

The content of the first hard phase (% by volume), the content of the binder phase (% by volume), and the content of the second hard phase (% by volume) of the cemented carbide of each sample were measured by the method described in Embodiment 1. The results are shown in Table 4. In Table 4, it was confirmed that the cemented carbide having a total content of the first hard phase, the binder phase, and the second hard phase in an amount of less than 100% by volume further contained a phase based on VC or Cr₃C₂ (e.g., a (Cr, W, V) C phase) and/or a TiCN phase.

TABLE 4

| | Cemented carbide | | | | |
|---|---|---|---|---|---|
| | | | | First hard | Co |
| | First hard | Binder | Second hard | phase + binder | con- |
| | phase | phase | phase | phase | tent |
| Sample | % by | % by | % by | % by | % by |
| No. | volume | volume | volume | volume | mass |
| 1 | 84.5 | 13.0 | 0 | 97.5 | 8.0 |
| 2 | 83.4 | 12.9 | 1.2 | 96.3 | 8.0 |
| 3 | 83.3 | 13.1 | 1.2 | 96.4 | 8.0 |
| 4 | 83.4 | 13.0 | 1.2 | 96.4 | 8.0 |
| 5 | 93.8 | 5.1 | 0 | 98.9 | 3.0 |
| 6 | 78.2 | 20.8 | 0 | 99.0 | 13.0 |
| 7 | 84.3 | 13.1 | 0 | 97.4 | 4.2 |
| 8 | 83.1 | 13.0 | 1.1 | 96.1 | 7.5 |
| 9 | 84.9 | 12.4 | 0 | 97.3 | 7.5 |
| 10 | 82.6 | 15.0 | 0 | 97.6 | 7.5 |
| 11 | 84.2 | 13.5 | 0 | 97.7 | 7.5 |
| 12 | 70.0 | 11.6 | 16 | 81.6 | 8.0 |
| 101 | 84.4 | 12.9 | 0 | 97.3 | 8.0 |
| 102 | 84.3 | 13.1 | 0 | 97.4 | 8.0 |
| 103 | 84.5 | 13.0 | 0 | 97.5 | 8.0 |
| 104 | 84.8 | 13.0 | 0 | 97.8 | 8.0 |
| 105 | 84.5 | 13.1 | 0 | 97.6 | 8.0 |
| 106 | 84.8 | 13.1 | 0 | 97.9 | 8.0 |
| 107 | 94.0 | 4.8 | 0 | 98.8 | 2.8 |
| 108 | 77.4 | 21.3 | 0 | 98.7 | 13.5 |
| 109 | 84.8 | 12.9 | 0 | 97.7 | 3.8 |
| 110 | 68.1 | 11.6 | 0 | 79.7 | 8.0 |

### <Median of Areas and Coefficient of Variation of Areas of Tungsten Carbide Particles, Cobalt Content of Binder Phase, and Composition, Median of Areas, and Coefficient of Variation of Areas of Second Hard Phase>

In the cemented carbide of each sample, the median of areas and the coefficient of variation of the areas of the tungsten carbide particles, the cobalt content of the binder phase, the composition of the second hard phase, and the median of areas and the coefficient of variation of the areas of the second hard phase were measured in the methods described in Embodiment 1. The results are shown in Table 5. From the cobalt content of the binder phase, the cobalt content of the cemented carbide was calculated. The results are shown in Table 4.

TABLE 5

| | | | Binder | | | |
|---|---|---|---|---|---|---|
| | WC particle | | phase | Second hard phase | | |
| | Area | | Co | | Area | |
| Sample | Median | Coefficient of | content | | Median | Coefficient of |
| No. | μm² | variation | % | Composition | μm² | variation |
| 1 | 0.106 | 0.92 | 100 | — | — | — |
| 2 | 0.092 | 1.08 | 100 | TiNbC | 0.06 | 3.10 |
| 3 | 0.080 | 0.87 | 100 | TiNbN | 0.002 | 0.49 |
| 4 | 0.084 | 0.86 | 100 | TiNbCN | 0.012 | 1.30 |
| 5 | 0.078 | 0.88 | 100 | — | — | — |
| 6 | 0.152 | 1.11 | 100 | — | — | — |
| 7 | 0.108 | 1.02 | 53 | — | — | — |
| 8 | 0.100 | 1.05 | 94 | TiNbCN | 0.003 | 0.51 |
| 9 | 0.100 | 1.02 | 94 | — | — | — |
| 10 | 0.088 | 1.03 | 94 | — | — | — |
| 11 | 0.087 | 0.99 | 94 | — | — | — |
| 12 | 0.080 | 0.95 | 100 | TiNbCN | 0.048 | 2.98 |
| 101 | 0.108 | 1.12 | 100 | — | — | — |
| 102 | 0.112 | 1.05 | 100 | — | — | — |
| 103 | 0.102 | 0.86 | 100 | — | — | — |
| 104 | 0.076 | 1.17 | 100 | — | — | — |
| 105 | 0.092 | 1.20 | 100 | — | — | — |
| 106 | 0.088 | 1.12 | 100 | — | — | — |
| 107 | 0.100 | 1.13 | 100 | — | — | — |
| 108 | 0.074 | 1.14 | 100 | — | — | — |
| 109 | 0.156 | 1.29 | 48 | — | — | — |
| 110 | 0.120 | 1.06 | 100 | TiNbCN | 0.07 | 3.70 |

### <Hardness>

The hardness H₂₅ of the cemented carbide at 25° C. and the hardness H₆₀₀ of the cemented carbide at 600° C. of each sample were measured in the methods described in Embodiment 1, to calculate the percentage (H₆₀₀/H₂₅)×100. The results are shown in Table 6.

<c/M>

In the cemented carbide of each sample, the content M of the binder phase based on mass and the specific heat c at 600° C. were measured in the methods described in Embodiment 1, to calculate the ratio c/M. The results are shown in Table 6.

TABLE 6

| | | | | | | | Cutting |
|---|---|---|---|---|---|---|---|
| | Hardness | | | Content M | Specific | | test |
| | H₂₅ | H₆₀₀ | | of binder | heat c | | Cutting |
| Sample | @25° C. | @600° C. | (H₆₀₀/H₂₅) × 100 | phase | @600 | | length |
| No. | GPa | GPa | % | % by mass | J/g/K | c/M | m |
| 1 | 19.5 | 10.5 | 53.8 | 8.0 | 0.271 | 0.034 | 8 |
| 2 | 20.1 | 12.2 | 60.7 | 8.0 | 0.308 | 0.039 | 11 |
| 3 | 20.3 | 14.1 | 69.5 | 8.0 | 0.324 | 0.041 | 14 |
| 4 | 20.0 | 13.0 | 65.0 | 8.0 | 0.353 | 0.044 | 16 |
| 5 | 23.1 | 12.6 | 54.5 | 3.0 | 0.103 | 0.034 | 7 |
| 6 | 13.2 | 7.1 | 53.8 | 13.0 | 0.481 | 0.037 | 7 |
| 7 | 18.4 | 9.3 | 50.5 | 8.0 | 0.289 | 0.036 | 9 |
| 8 | 20.2 | 13.3 | 65.8 | 8.0 | 0.267 | 0.033 | 12 |
| 9 | 20.7 | 12.2 | 58.9 | 8.0 | 0.257 | 0.032 | 10 |
| 10 | 20.4 | 12.1 | 59.3 | 8.0 | 0.312 | 0.039 | 11 |
| 11 | 20.9 | 13.0 | 62.2 | 8.0 | 0.323 | 0.040 | 12 |
| 12 | 21.1 | 13.1 | 62.1 | 8.0 | 0.283 | 0.035 | 10 |
| 101 | 19.3 | 9.5 | 49.2 | 8.0 | 0.248 | 0.031 | 4 |
| 102 | 19.5 | 9.7 | 49.7 | 8.0 | 0.242 | 0.030 | 4 |
| 103 | 19.4 | 9.4 | 48.5 | 8.0 | 0.238 | 0.030 | 4 |
| 104 | 19.6 | 10.1 | 51.5 | 8.0 | 0.233 | 0.029 | 4 |
| 105 | 19.7 | 9.5 | 48.2 | 8.0 | 0.268 | 0.034 | 5 |
| 106 | 19.6 | 9.6 | 49.0 | 8.0 | 0.259 | 0.032 | 4 |
| 107 | 23.3 | 11.1 | 47.6 | 2.8 | 0.092 | 0.033 | 4 |
| 108 | 12.3 | 6.7 | 54.6 | 13.5 | 0.603 | 0.045 | 5 |
| 109 | 18.0 | 8.8 | 48.9 | 8.0 | 0.275 | 0.034 | 5 |
| 110 | 20.0 | 10.2 | 51.0 | 8.0 | 0.247 | 0.031 | 4 |

### [Cutting Test]

A round bar formed of the cemented carbide of each sample was processed to produce a ball end mill having a blade diameter of φ6 mm. The ball end mill was used to process the sides of a workpiece formed of Inconel 718. The processing conditions were a cutting speed Vc 75 m/min, a feed per tooth fz 0.05 mm/tooth, a cutting depth (axial direction) ap 0.3 mm, a cutting depth (radial direction) ae 0.3 mm, and a wet cutting. The cutting length until the flank face wear amount of the cutting tool reached 100 μm was measured. When the cutting length was 6 m or more, it was determined that the tool life is long. It is shown that the longer the cutting length, the longer the tool life. The results are shown in the “Cutting length” column of the “Cutting test” in Table 6. The above processing conditions correspond to high-speed processing of a heat-resistant alloy.

### DISCUSSION

The cemented carbides and the cutting tools of Sample 1 to Sample 12 correspond to the Examples. It was confirmed that these cutting tools had a long tool life. The cemented carbides and the cutting tools of Sample 101 to Sample 110 correspond to the Comparative Examples. These cutting tools had an insufficient tool life.

The embodiments and the Examples of the present disclosure have been described as above, and it is also planned from the beginning to appropriately combine the configurations of the embodiments and the Examples described above and to modify these in various ways.

The embodiments and the Examples disclosed this time should be considered to be illustrative in all respects and non-limiting. The scope of the present invention is defined by the Claims, not by the above embodiments and Examples, and is intended to include all modifications within the meaning and scope equivalent to the Claims.

### REFERENCE SIGNS LIST

10 Cutting tool; 11 Cutting edge.

1. A cemented carbide comprising a first hard phase consisting of a plurality of tungsten carbide particles and a binder phase containing cobalt, wherein
a total content of the first hard phase and the binder phase of the cemented carbide is 80.0% by volume or more,
a content of the binder phase of the cemented carbide is 5.0% by volume or more and 21.0% by volume or less,
a cobalt content of the binder phase is 50% by mass or more,
a percentage (H₆₀₀/H₂₅)×100 of a hardness H₆₀₀ of the cemented carbide at 600° C. to a hardness H₂₅ of the cemented carbide at 25° C. is 50% or more and 70% or less,
a ratio c/M of a specific heat c of the cemented carbide at 600° C. to a content M of the binder phase of the cemented carbide based on mass is 0.032 or more and 0.044 or less,
the content M of the binder phase of the cemented carbide based on mass is 3.0% by mass or more and 13.0% by mass or less, and
a unit of the specific heat c is J/g·K.

2. The cemented carbide according to claim 1,
wherein the percentage (H₆₀₀/H₂₅)×100 is 58% or more and 70% or less, the ratio c/M is 0.037 or more and 0.044 or less,
the cemented carbide further comprises a second hard phase, and
the second hard phase consists of at least one first compound selected from the group consisting of TiNbC, TiNbN, and TiNbCN.

3. The cemented carbide according to claim 2,
wherein in a cross section of the cemented carbide, a median of areas of the second hard phase is 0.003 μm² or more and 0.050 μm² or less, and
a coefficient of variation of the areas of the second hard phase is 0.50 or more and 3.00 or less.

4. The cemented carbide according to claim 1,
wherein in a cross section of the cemented carbide, a median of areas of the tungsten carbide particles is 0.080 μm² or more and 0.150 μm² or less, and
a coefficient of variation of the areas of the tungsten carbide particles is 0.85 or more and 1.10 or less.

5. A cutting tool comprising a cutting edge consisting of the cemented carbide according to claim 1.
